(19) United States
(12) Patent Application Publication
(10) Pub. No.: US 2003/0166809 A1
(43) Pub. Date: Sep. 4, 2003

(54) Process for preparation of butyl rubber having broad molecular weight distribution

(76) Inventor: Adam Gronowski, Sarnia (CA)

Correspondence Address: BAYER POLYMERS LLC, 100 BAYER ROAD, PITTSBURGH, PA, 15205, US

(21) Appl. No.: 10/275,042

(22) PCT Filed: May 1, 2001
(86) PCT No.: PCT/CA01/00602

(30) Foreign Application Priority Data
May 5, 2000 (CA) 2,308,257

(51) Int. Cl. C08F 4/00

(52) U.S. Cl. 526/237; 526/335; 526/348.4; 526/348.5; 526/348.6; 526/348.7

(57) ABSTRACT

A process for preparing a butyl polymer having a broad molecular weight distribution. The process comprises the step of contacting a C₄ to C₈ monoolefin monomers with a C₄ to C₁₄ multiolefin monomer at a temperature in the range of from about −100° C. to about +50° C. in the presence of a diluent and a catalyst mixture comprising a major amount of a dialkylalumium halide, a minor amount of a monoalkylaluminum dihalide, and a minute amount of an aluminoxane.

In one of its aspects, the present invention relates to an improved, catalytic, solution process for preparing butyl rubber polymers. More particularly, the present invention relates to such a process for preparing butyl rubber polymers with good isobutylene conversions, such polymers having a broad molecular weight distribution (MWD), at polymerization temperatures of −100° C. to +50° C.

Canadian patent application S.N. 2,252,295 discloses a process for the preparation of butyl rubber using a catalyst system comprising a dialkyl aluminum halide, a monoalkyl aluminum halide and an aluminoxane or water. Surprisingly, it has now been found that, when aluminoxane is used in such a process, the butyl rubber so-produced has a broad molecular weight distribution.

The physical properties and polymer processing characteristics are well known to depend on weight average molecular weight (M_{w}), and number average molecular weight (Mₙ). In general, the tensile strength and modulus of vulcanizates are dependent on number average molecular weight. The processability of elastomers is dependent on both M_{w} and M_{w}/Mₙ (molecular weight distribution or MWD). For example, the mill behaviour of several types of rubber has been classified relative to M_{w}/Mₙ. [J. Appl. Polym. Sci., vol. 12, pp.1589-1600 (1968).]

Butyl rubber having a broad molecular weight distribution has been found to exhibit excellent Banbury mixing characteristics and is very resistant to flow under storage conditions (cold flow). The molecular weight distribution of butyl rubber also controls the extent of extrusion die swell. Therefore, to produce fabricated articles that are of constant size and shape, it is highly useful to have a control over M_{w} and M_{w}/Mₙ.

Butyl rubbers with broad molecular weight distribution also have enhanced green strength over narrower molecular weight distribution rubbers. The improved green strength or uncured stock strength results in improved manufacturing operations (e.g. inner tube manufacture) in that the uncured rubber articles are much stronger and less subject to distortion.

U.S. Pat. No. 3,780,002 teaches a method of preparing a broad molecular weight distribution butyl rubber in methyl chloride as the diluent. This is purportedly accomplished by utilising a mixed catalyst system (e.g., AlCl₃ and TiCl₄ or AlCl₃ and SnCl₄) where each of the metal compounds is an active catalyst independently capable of initiating polymerization. The molecular weight distribution of the so-obtained butyl rubber purportedly was greater than 5.0 and up to about 7.6.

Despite the advances in the art, there is still a need for a convenient method for producing butyl rubber having a broad molecular weight distribution.

It is the object of the present invention to provide a novel method for the manufacture of butyl rubber.

Accordingly, the present process provides a process for preparing a butyl polymer having a broad molecular weight distribution, the process comprising the step of:

contacting a C₄ to C₈ monoolefin monomer with a C₄ to C₁₄ multiolefin monomer at a temperature in the range of from about −100° C. to about +50° C. in the presence of a diluent and a catalyst mixture comprising a major amount of a dialkylaluminum halide, a minor amount of a monoalkylaluminum dihalide, and a minute amount of an aluminoxane.

More specifically, the present invention is directed to the preparation of butyl rubber polymers having a molecular weight distribution greater than 4.0 by reacting a C₄ to C₈ olefin monomer, preferably a C₄ to C₈ isomonoolefin with a C₄ to C₁₄ multiolefin monomer, preferably a C₄ to C₁₀ conjugated diolefin monomer, at temperatures ranging from −100° C. to +50° C., preferably from −80° C. to −20° C., in the presence of a diluent, preferably an aliphatic hydrocarbon diluent, and a catalyst mixture comprising: (A) a major amount, e.g., 0.01 to 2.0 wt. percent of a dialkylaluminum halide, (B) a minor amount, e.g., 0.002 to 0.4 wt. percent of a monoalkylaluminum dihalide (the weight percent being based on the total of the polymerizable monomers present) with the monoalkylaluminum dihalide always representing no more than about 20 mole percent of the catalyst mixture (based on monohalide plus dihalide) and (C) a minute amount of an aluminoxane purposely added to activate the catalyst.

As mentioned hereinabove, the present process relates to the preparation of butyl rubber polymers. The term “butyl rubber” as used throughout this specification is intended to denote polymers prepared by reacting a major portion, e.g., from about 70 to 99.5 parts by weight, usually 80 to 99.5 parts by weight of an isomonoolefin, such as isobutylene, with a minor portion, e.g., about 30 to 0.5 parts by weight, usually 20 to 0.5 parts by weight, of a multiolefin, e.g., a conjugated diolefin, such as isoprene or butadiene, for each 100 weight parts of these monomers reacted. The isoolefin, in general, is a C₄ to C₈ compound , e.g., isobutylene, 2-methyl-1-butene, 3-methyl-1-butene, 2-methyl-2-butene, and 4-methyl-1-pentene.

Those of skill in the art will recognize that it is possible to include an optional third monomer to produce a butyl terpolymer. For example, to possible to include a styrenic monomer in the monomer mixture, preferably in an amount up to about 15 percent by weight of the monomer mixture. The preferred styrenic monomer may be selected from the group comprising p-methylstyrene, styrene, α-methylstyrene, p-chlorostyrene, p-methoxystyrene, indene (including indene derivatives) and mixtures thereof. The most preferred styrenic monomer may be selected from the group comprising styrene, p-methylstyrene and mixtures thereof. Other suitable copolymerizable termonomers will be apparent to those of skill in the art.

The present process is conducted in a diluent. While the diluent may be conventional (e.g., methyl chloride) it is particularly preferred to utilize an aliphatic hydrocarbon diluent. Suitable aliphatic hydrocarbon diluents which can be used in accordance with the present process include, but are not limited to, the following: C₄ to C₈ saturated aliphatic and alicyclic hydrocarbons, such as pentane, hexane, heptane, isooctane, methylcyclohexane, cyclohexane, etc. Preferably the C₅ to C₆ normal paraffins are used, e.g., n-pentane and n-hexane. The same saturated hydrocarbons serve as “solvent” for the catalyst mixture. The concentration of diluent during polymerization may range from 0 to about 50 volume percent, and more preferably from 0 to about 25 volume percent.

The catalyst mixture used in the present process comprises a mixture of from about 1 to about 20 mole percent of a monoalkylaluminum dihalide, from about 80 to about 99 mole percent of a dialkylaluminum monohalide and minute amounts of aluminoxane. Usually the catalyst mixture will contain from about 1 to about 15 mole percent of the monoalkylaluminum dihalide and from about 85 to about 99 mole percent of the dialkylaluminum monohalide. Preferably, however, and in order to achieve the most advantageous combination of ease of polymerization coupled with catalyst efficiency and good temperature control over the polymerization reaction the catalyst mixture contains from about 2 to about 10 mole percent of the monoalkylaluminum dihalide and from about 90 to 98 mole percent of the dialkylaluminum monohalide.

Usually the dialkylaluminum monohalide employed in accordance with this invention will be a C₂ to C₁₆ low molecular weight dialkylaluminum monochloride, wherein each alkyl group contains from 1 to 8 carbon atoms. Preferably, C₂ to C₈ dialkylaluminum chlorides are used, wherein each alkyl group contains from 1 to 4 carbon atoms. Suitable exemplary preferred dialkylaluminum monochlorides which can be used in accordance with this invention include, but are not limited to, a member selected from the group comprising dimethylaluminum chloride, diethylaluminum chloride, di(n-propyl)aluminum chloride, diisopropylaluminum chloride, di(n-butyl)aluminum chloride, diisobutylaluminum chloride, or any of the other homologous compounds.

The monoalkylaluminum dihalides employed in accordance with the present process may be selected from the C₁ to C₈ monoalkylaluminum dihalides, and preferably are C₁ to C₄ monoalkylaluminum dihalides independently containing essentially the same alkyl groups as mentioned hereinabove in conjunction with the description of the dialkylaluminum monochlorides. Suitable exemplary preferred C₁ to C₄ monoalkylaluminum dihalides which can be employed satisfactorily in accordance with the present process include, but are not limited to, the following: methylaluminum dichloride, ethylaluminum dichloride, propylaluminum dichlorides, butylaluminum dichlorides, isobutylaluminum dichloride, etc.

As stated hereinabove, the present process is conducted in the presence of an aluminoxane. The aluminoxane component useful as a catalyst activator typically is an oligomeric aluminum compound represented by the general formula (R²—Al—O)ₙ, which is a cyclic compound, or R₂(R₂—Al—O)ₙAlR²₂, which is a linear compound. In the general aluminoxane formula, R² is independently a C₁ to C₁₀ hydrocarbyl radical (for example, methyl, ethyl, propyl, butyl or pentyl) and n is an integer of from 1 to about 100. R² may also be, independently, halogen, including fluorine, chlorine and iodine, and other non-hydrocarbyl monovalent ligands such as amide, alkoxide and the like, provided that not more than 25 mol % of R² are non-hydrocarbyl as described here. Most preferably, R² is methyl and n is at least 4.

Aluminoxanes can be prepared by various procedures known in the art. For example, an aluminum alkyl may be treated with water dissolved in an inert organic solvent, or it may be contacted with a hydrated salt, such as hydrated copper sulfate suspended in an inert organic solvent, to yield an aluminoxane. Generally, however prepared, the reaction of an aluminum alkyl with a limited amount of water yields a mixture of the linear and cyclic species, and also there is a possibility of interchain complexation (crosslinking). The catalytic efficiency of aluminoxanes is dependent not only on a given preparative procedure but also on a deterioration in the catalytic activity (“ageing”) upon storage, unless appropriately stabilized. Methylaluminoxane and modified methylaluminoxanes are preferred. For further descriptions, see, for example, one or more of the following United States patents:

| | | |
|---|---|---|
| 4,665,208 | 4,952,540 | 5,041,584 |
| 5,091,352 | 5,206,199 | 5,204,419 |
| 4,874,734 | 4,924,018 | 4,908,463 |
| 4,968,827 | 5,329,032 | 5,248,801 |
| 5,235,081 | 5,157,137 | 5,103,031 |

In the present invention, it is preferred that aluminoxane is added to the catalyst solution in such an amount that the reaction feed contains from about 0.3 to about 3.0 weight percent, more preferably from about 1.0 to about 2.5 weight percent of aluminoxane, based on the total weight of the aluminum-containing components of the catalyst system.

The application of the present process results in the production of butyl rubber polymers having a broad MWD. Preferably, the MWD is greater than about 3.5, more preferably greater than about 4.0, even more preferably in the range of from about 4.0 to about 10.0, most preferably in the range of from about 5.0 to about 8.0. Thus, it has been unexpectedly observed that, when minute amounts of aluminoxanes are present in the reaction feed, the resulting butyl rubber polymer will have a broad MWD.

Embodiments of the present invention will be illustrated with reference to the following Examples, which should not be use to construe or limit the scope of the present invention.

### EXAMPLE 1

To a 50 mL Erlenmeyer flask, 3.75 mL of distilled hexane, 4.62 mL Et₂AlCl (1.0 M solution in hexanes) and 0.38 mL EtAlCl₂ (1.0 M solution in hexanes) were added at room temperature forming a catalyst solution.

To a 250 mL 3-neck flask equipped with an overhead stirrer, 40.0 mL of isobutylene at −75° C. were added, followed by 8.0 mL hexane at room temperature and 1.0 mL isoprene at room temperature. The reaction mixture was cooled down to −75° C. and 1.8 mL of the catalyst solution was added to start the reaction.

The reaction was carried out in an MBRAUN™ dry box under the atmosphere of dry nitrogen. The temperature changes during the reaction were followed by a thermocouple. After 20 minutes, the reaction was terminated by adding 5 mL of ethanol into the reaction mixture.

The polymer solution was poured on an aluminum tray lined with Teflon and the solvent and unreacted monomers were allowed to evaporate in a vacuum oven at 70° C.

The gravimetrically determined yield was 14.8 wt. percent, Mₙ=46 200, M_{w}=126 500, M_{w}/Mₙ=2.7, and isoprene content was 1.3 mol percent.

This Example represents a conventional method for production of butyl rubber (U.S. Pat. No. 3,361,725 [Parker] and is provided for comparative purposes.

### EXAMPLE 2

The methodology of Example 1 was repeated except 25_L of MAO was added directly to the catalyst solution. After stirring, 1.8 mL of this solution was immediately used to start the reaction.

The polymer yield was 33.8 wt. percent, Mₙ=139 400, M_{w}=506 100, M_{w}/Mₙ=3.9 and isoprene content was 1.6 mol percent.

### EXAMPLE 3

The methodology of Example 1 was repeated except 75_L of MAO was added directly to the catalyst solution. After stirring, 1.8 mL of this solution was immediately used to start the reaction.

The polymer yield was 55.3 wt. percent, Mₙ=117 200, M_{w}=514 300, M_{w}/Mₙ=4.4, and isoprene content was 1.8 mol percent.

### EXAMPLE 4

The methodology of Example 1 was repeated except 100_L of MAO was added directly to the catalyst solution. After stirring, 1.8 mL of this solution was immediately used to start the reaction.

The polymer yield was 54.5 wt. percent, Mₙ=83 800, M_{w}=523 900, M_{w}/Mₙ=6.3, and isoprene content was 1.9 mol percent.

### EXAMPLE 5

The methodology of Example 1 was repeated except 175_L of MAO was added directly to the catalyst solution. After stirring, 1.8 mL of this solution was immediately used to start the reaction.

The polymer yield was 57.1 wt. percent, Mₙ=67 900, M_{w}=517 500, M_{w}/Mₙ=7.6, and isoprene content was 1.9 mol percent.

The results from Examples 1-5 are presented in Table 1. These results illustrate the advantageous combination of yield, MWD and isoprene content in Examples 2-5, particularly in Examples 3-5, compared to those properties for the polymer of Example 1.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

TABLE 1

| | MAO added to the | Yield | | | | Isoprene in the |
|---|---|---|---|---|---|---|
| Example | catalyst [_L] | [wt. %] | Mₙ | M_{w} | M_{w}/Mₙ | rubber [mol %] |
| 1 | 0 | 14.8 | 46 200 | 126 500 | 2.7 | 1.3 |
| 2 | 25 | 33.8 | 139 400 | 506 100 | 3.6 | 1.6 |
| 3 | 75 | 55.3 | 117 200 | 514 300 | 4.4 | 1.8 |
| 4 | 100 | 54.5 | 83 800 | 523 900 | 6.3 | 1.9 |
| 5 | 175 | 57.1 | 67 900 | 517 500 | 7.6 | 1.9 |

What is claimed is:

1. A process for preparing a butyl polymer having a broad molecular weight distribution, the process comprising the step of:
contacting a C₄ to C₈ monoolefin monomers with a C₄ to C₁₄ multiolefin monomer at a temperature in the range of from about −100° C. to about +50° C. in the presence of a diluent and a catalyst mixture comprising a major amount of a dialkylalumium halide, a minor amount of a monoalkylaluminum dihalide, and a minute amount of an aluminoxane.

2. The process defined in claim 1, wherein said catalyst mixture contains from about 80 to about 99 mol percent of the dialkylaluminum halide and from about 1 to about 20 mol percent of the monoalkylaluminum dihalide, and when the amount of aluminoxane added to the catalyst solution is such that the content of aluminoxane is in the range of from about 0.3 to about 3.0 weight percent based on the total weight of the aluminum-containing components of the catalyst mixture.

3. The process defined in claim 2, wherein aluminoxane is added directly to the catalyst solution and the resulting homogenous solution is used directly to initiate polymerization reactions.

4. The process defined in any one of claims 1-3, wherein the diluent is a C₄ to C₈ saturated aliphatic hydrocarbon.

5. The process defined in any one of claims 1-4, wherein the C₄ to C₈ monoolefin is an isomonoolefin.

6. The process defined in any one of claims 1-5, wherein the C₄ to C₁₄ multiolefin is a C₄ to C₁₀ conjugated diolefin.

7. The process defined in any one of claims 1-6, wherein from about 0.01 to about 2.0 wt. percent of the dialkylaluminum halide is employed, based on the total of said monomers present.

8. The process defined in any one of claims 1-7, wherein from about 0.002 to about 0.4 wt. percent of the monoalkylaluminum dihalide is employed, based on the total of said monomers present.

9. The process defined in any one of claims 1-8, wherein the amount of aluminoxane in the reaction feed is in the range of from about 0.3 to about 3.0 weight percent based on the total weight of the aluminum-containing components of the catalyst mixture.

10. The process defined in any one of claims 1-9, wherein the temperature is in the range of from about −80° C. to about −20° C.

11. A process for producing a solution butyl rubber polymer having a weight average molecular weight of at least about 400,000, the process comprising the step of:
reacting a C₄ to C₈ isomonoolefin with a C₄ to C₁₀ conjugated diolefin at a temperature in the range of from about about −80° C. to −20° C. in the presence of a C₄ to C₈ paraffinic diluent and a catalyst mixture comprising: (i) from about 85 to about 99 mol percent of a C₂ to C₁₆ dialkylaluminum halide component wherein each alkyl group contains from 1 to 8 carbon atoms; (ii) from about 1 to about 15 mol percent of a C₁ to C₈ monoalkylaluminum dihalide component wherein each alkyl group contains from 1 to 8 carbon atoms, and (iii) an aluminoxane present in an amount in the range of from about 0.3 to about 3.0 weight percent based on the total weight of the aluminum-containing components of the catalyst mixture.

12. The process defined in any one of claims 1-11, wherein the dialkylaluminum halide is a C₂ to C₈ dialkylaluminum chloride wherein each alkyl group contains from 1 to 4 carbon atoms.

13. The process defined in any one of claims 1-12, wherein the monoalkylaluminum halide is a C₁ to C₄ alkylaluminum dichloride.

14. The process defined in any one of claims 1-13, wherein the aluminoxane comprises methylaluminoxane.

15. The process defined in any one of claims 1-14, wherein the butyl polymer comprises a molecular weight distribution of at least about 3.5.

16. The process defined in any one of claims 1-14, wherein the butyl polymer comprises a molecular weight distribution of at least about 4.0.

17. The process defined in any one of claims 1-14, wherein the butyl polymer comprises a molecular weight distribution in the range of from about 4.0 to about 10.0.

18. The process defined in any one of claims 1-14, wherein the butyl polymer comprises a molecular weight distribution in the range of from about 5.0 about 8.0.

19. The process defined in any one of claims 1-18, wherein the aluminoxane is present in an amount in the range of from about 1.0 to about 2.5 weight percent based on the total weight of the aluminum-containing components of the catalyst mixture.
